(19) United States
(12) Patent Application Publication
(10) Pub. No.: US 2011/0316294 A1
(43) Pub. Date: Dec. 29, 2011

(54) DOOR STRIKER UNIT FOR VEHICLE

(75) Inventors: Chul Kim, Asan Chungcheongnam-Do (KR); Byung Sun Kim, Asan (KR); Jae Hwan Jung, Pyeongtaek Gyeonggi-Do (KR)

(73) Assignee: Hyundai Motor Company, Seoul (KR)

(21) Appl. No.: 12/954,049

(22) Filed: Nov. 24, 2010

(30) Foreign Application Priority Data
Jun. 28, 2010 (KR) 10-2010-0061504

(51) Int. Cl. E05B 15/02

(52) U.S. Cl. 292/340

(57) ABSTRACT

The present invention relates to a door striker unit for a vehicle. The door striker unit for a vehicle includes a retainer connected to a rear side of the vehicle's side outer panel, a engaging plate connected to a rear surface of the retainer, and a striker connected to the engaging plate and positioned on a front side of the vehicle's side outer panel, wherein the engaging plate includes a welding portion welded to the retainer, an engaging portion having an integral bolt engaging portion for connection with the striker, and a connecting portion integrally connecting the welding portion and the engaging portion, wherein the connecting portion comprises a protruding curved portion.

### CROSS-REFERENCE TO RELATED APPLICATION

This application claims priority to and the benefit of Korean Patent Application No. 10-2010-0061504 filed in the Korean Intellectual Property Office on Jun. 28, 2010, the entire contents of which are incorporated herein by reference.

### BACKGROUND OF THE INVENTION

(a) Field of the Invention

The present invention relates to a door striker unit for a vehicle. More particularly, the present invention relates to a door striker unit for a vehicle that improves assembly and that minimizes variations in assembly.

(b) Description of the Related Art

Generally, a door striker unit is mounted to a side outer panel of a vehicle, and it engages a door latch when the door is closed.

A conventional door striker unit 1, as shown in FIG. 1 and FIG. 2, includes an engaging plate 10, a retainer 20 and a striker 30. The engaging plate 10 is formed in a plate shape and includes an engaging portion 11 which is formed in a rear side of the engaging plate 10, a welding portion 13 on a front side of the engaging plate 10, and a connecting portion 15 integrally connecting the engaging portion 11 and the welding portion 13. One or more weld nuts 40 are welded to the engaging portion, and the welding portion 13 is connected to a rear side of a retainer 20 by spot welding. The retainer 20 is connected to a rear side of a side outer panel 3 of a vehicle by welding. The striker 30 includes a striker plate 31 and a striker ring 33, with the ends of the striker ring 33 insertedly connected to the striker plate 31.

Generally, after the vehicle has been painted, the striker 30 is positioned on the side outer panel 3 of the vehicle and is assembled by engaging one or more penetration holes (not shown) formed in the striker plate 31 with the one or more weld nuts 40 of the engaging plate 10 using one or more bolts 50.

However, in assembling the conventional door striker unit 1, the one or more weld nuts 40 are connected to the engaging plate 10 by welding using a projection welding device. This frequently leads to assembly variations (e.g. variations in weld nut 40 position) that do not fall within the permissible range. As a result, the striker 30 often can not be properly positioned and engaged due to this variation of the weld nut 40 assembly.

As further shown and described, the engaging plate 10, formed having the welding portion 13, the engaging portion 11 and the connecting portions 15, has a planar cross section. Thus, when welding the welding portion 13 to the retainer 20, if the welding surface is bent or curved, then the engaging portion 11 may not sufficiently adhere to the retainer 20 This further leads to deterioration in striker 30 assembly.

A rubber mallet is often used to hit the striker 30 so as to adjust clearance between the striker 30 and a door latch (not shown) after assembly of the engaging plate 10 and the striker 30. However, the side outer panel 3 can be easily damaged or distorted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a door striker unit for a vehicle. The present door striker unit advantageously minimizes assembly variation, particularly by use of an engaging portion provided with a thread.

According to a preferred embodiment, a door striker unit for a vehicle includes a retainer connected to a rear side of a side outer panel of a vehicle, a engaging plate connected to a rear surface of the retainer, and a striker connected to the engaging plate on a front side of the side outer panel of a vehicle. The engaging plate may include a welding portion welded to the retainer; an engaging portion having a bolt engaging portion integrally formed thereto for connecting with the striker; and a connecting portion integrally connecting the welding portion and the engaging portion, the connecting portion comprising a protruding curved portion formed therein. In an exemplary embodiment, the bolt engaging portion may be formed as a cylindrical shape and comprises a thread formed therein. The curved portion may include a vertical curved portion formed closed to the welding portion and a horizontal curved portion formed closed to the engaging portion. In a preferred embodiment, the curved portion may be formed shaped as a protruding semicircle. The striker may include a striker plate and a striker ring connected to the striker plate. In a preferred embodiment, the striker plate may further include a marking groove formed therein that corresponds to a position of a marker formed in the side outer panel.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

FIG. 1 is a perspective view of a conventional door striker unit.

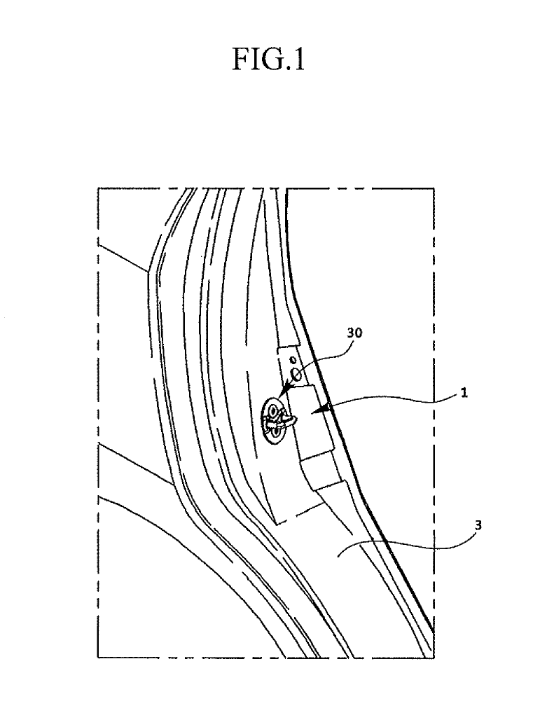

FIG. 2 is an exploded perspective view of a conventional door striker unit.

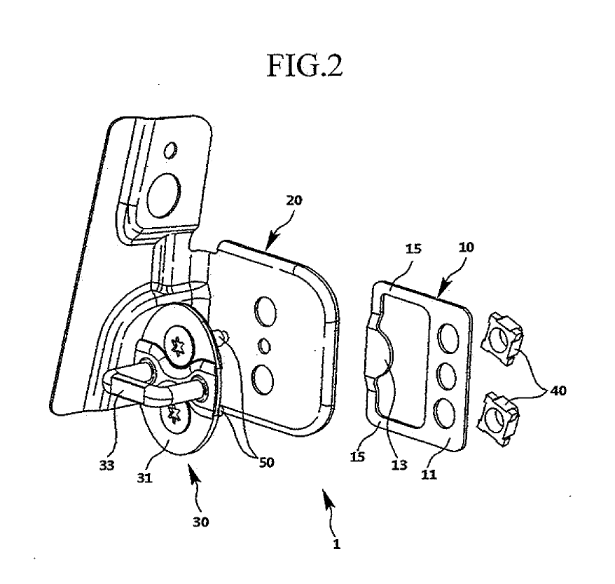

FIG. 3 is a perspective view of a door striker unit according to an exemplary embodiment of the present invention.

FIG. 4 is an exploded perspective view of the door striker unit shown in FIG. 3.

FIG. 5 is an exploded perspective view of a striker of a door striker unit according to an exemplary embodiment of the present invention.

FIG. 6 is a perspective view of an engaging plate of a door striker unit according to an exemplary embodiment of the present invention.

FIG. 7 is a cross-sectional view of a door striker unit according to an exemplary embodiment of the present invention.

FIG. 8 is a drawing showing functions of an engaging plate of a door striker unit according to an exemplary embodiment of the present invention.

FIG. 9 is a top plan view showing functions of an engaging plate of a door striker unit according to an exemplary embodiment of the present invention.

FIG. 10 is a side view showing functions of an engaging plate of a door striker unit according to an exemplary embodiment of the present invention.

### DESCRIPTION OF SYMBOLS

1: door striker unit
3: side outer panel
10: engaging plate
11: engaging portion
13: welding portion
15: connecting portion
17: bolt engaging portion
20: retainer
30: striker
31: striker plate
33: striker ring
50: bolt
M: marker
MG: marking groove
N: thread
C, C1, C2: curved portion

### DETAILED DESCRIPTION OF THE EMBODIMENTS

An exemplary embodiment of the present invention will hereinafter be described in detail with reference to the accompanying drawings.

In this description, similar or same reference numerals used for constituent elements of conventional art will be used for a door striker unit for a vehicle according to an exemplary embodiment of the present invention for better comprehension.

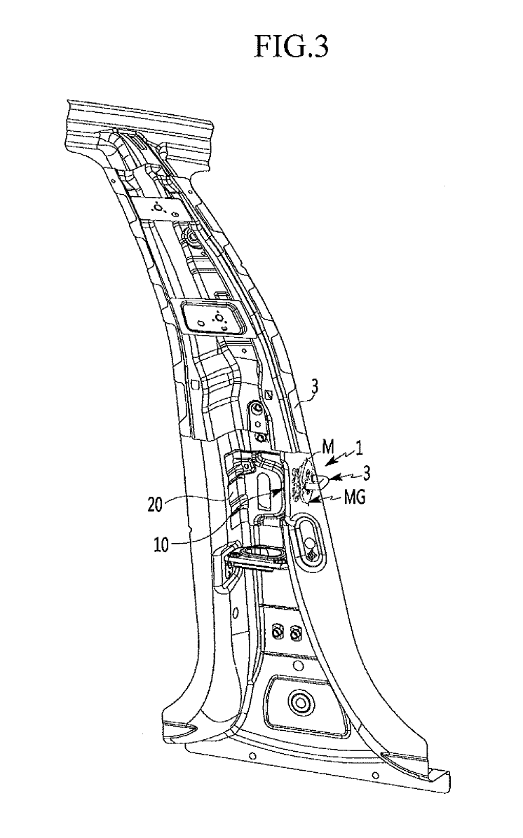

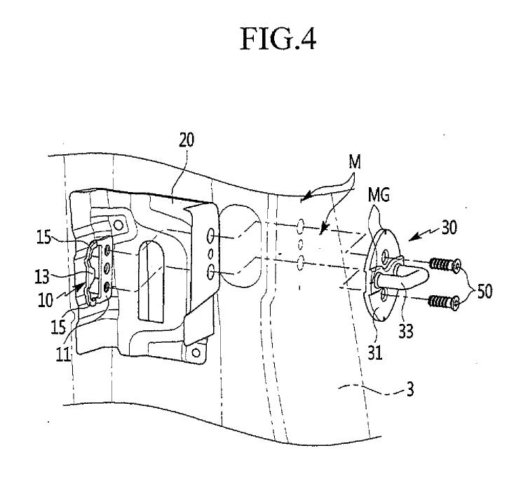

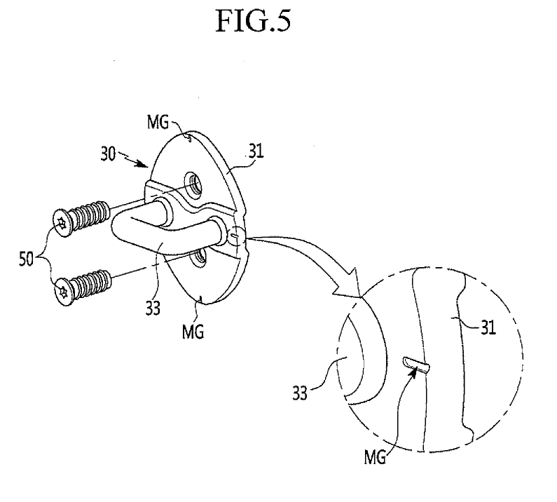

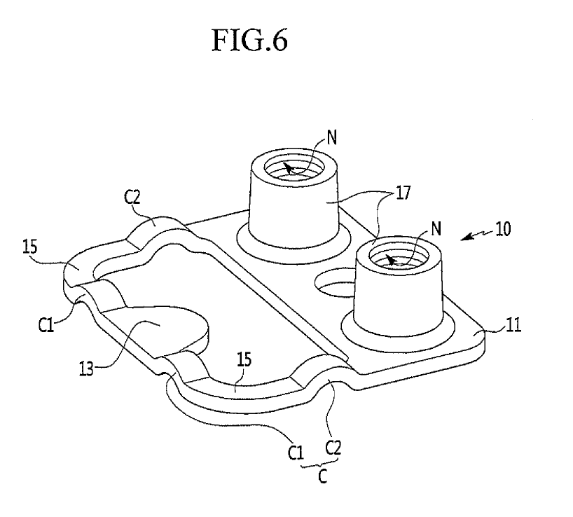

FIG. 3 is a perspective view of a door striker unit according to an exemplary embodiment of the present invention, and FIG. 4 is an exploded perspective view of the door striker unit shown in FIG. 3. FIG. 5 is a perspective view of a striker of a door striker unit according to an exemplary embodiment of the present invention and FIG. 6 is a perspective view of an engaging plate of a door striker unit according to an exemplary embodiment of the present invention.

Referring to FIGS. 3 and 4, a door striker unit 1 according to an exemplary embodiment of the present invention includes a retainer 20, an engaging plate 10 and a striker 30.

The retainer 20 is a type of a support panel that is used to solidly connect the engaging plate 10 to a side outer panel 3 of a vehicle. The retainer 20 is connected to a rear side of the vehicle's side outer panel 3 by any conventional techniques, such as welding.

The engaging plate 10 is connected to a rear side of the retainer 20, and is engaged with the striker 30, which is assembled and mounted on a front side of the vehicle's side outer panel 3.

As shown, the striker 30 includes a striker plate 31, which is connected to the engaging plate 10 using one or more bolts 50. The striker 30 also includes a striker ring 33 having two ends insertedly connected to the striker plate 31. When the vehicle door is closed, the striker ring 33 engages a door latch (not shown).

In a preferred embodiment, the striker plate 31 includes a marking groove MG formed to correspond with the position of a marker M formed to the vehicle's side outer panel 3. As such, assembly variation may be checked by checking the position of the marking groove MG while assembling the door striker unit.

The engaging plate 10, as shown in FIG. 6, includes a welding portion 13 for welding to the retainer 20, and an engaging portion 11 for connection to the welding portion 13 via a connecting portion 15 and for bolting to the striker 30.

As shown, in a preferred embodiment the welding portion 13 is shaped as a semi-circle and is connected to the rear sided of the retainer 20 by any conventional means, such as spot welding and the like.

As further, shown a bolt engaging portion 17 is integrally formed in the engaging portion 11, and can be bolted to the striker 30 with one or more bolts 50.

In a preferred embodiment, the bolt engaging portion 17 is cylindrically shaped and is provided with a thread N therein. On or more threaded bolts 50 can be inserted in the bolt engaging portion 17 to thereby connect the engaging portion 11 to the striker 30.

As shown, the engaging plate 10 having the integrally formed bolt engaging portion 17 replaces the conventional use of weld nuts, so that assembly variation may be reduced as compared with use of conventional weld nuts.

As further shown in FIG. 6, in a preferred embodiment the connecting portion 15 is integrally connected with the welding portion 13 and the engaging portion 11, and curved portions C are further formed in the connecting portion 15. For example, as shown, the curved portions 15 may include a vertical curved portion C1 formed close to the welding portion 13 and a horizontal curved portion C2 formed close to the engaging portion 15. While the vertical curved portion C1 and horizontal curved portion C2 are formed to protrude in the shape of a semi-circle in the drawings, it will be understood that present description is not intended to limit the invention to those exemplary embodiments and, thus, any other protrusion positions, number of protrusions, and protrusion shapes are also encompassed by the present invention. As such, the present invention is intended to cover not only the exemplary embodiment, but also various alternatives, modifications, equivalents and other embodiments.

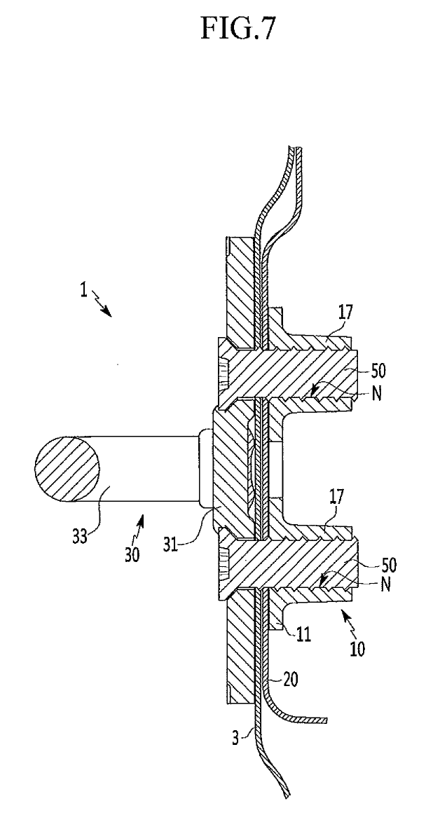

As shown, for example in FIG. 7, the door striker unit for a vehicle according to the exemplary embodiment of the present invention can be assembled by welding the welding portion 13 of the engaging plate 10 to the rear side of the retainer 20, and welding the retainer 20 to the rear side of vehicle's side outer panel 3. The striker plate 31 of the striker 30 can then be positioned on the front side of the vehicle's side outer panel 3, and the striker plate 31 and the bolt engaging portion 17 bolted with the bolts 50.

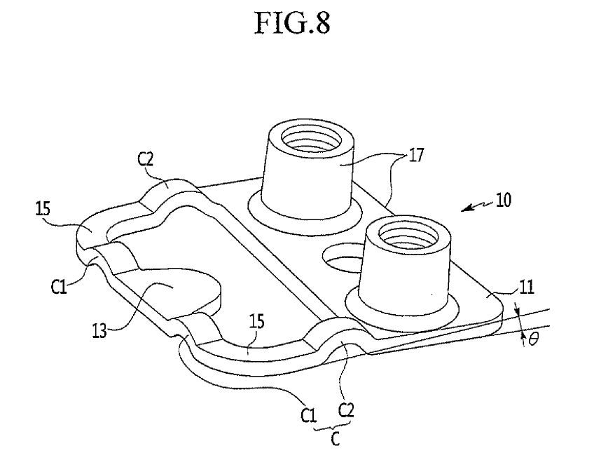

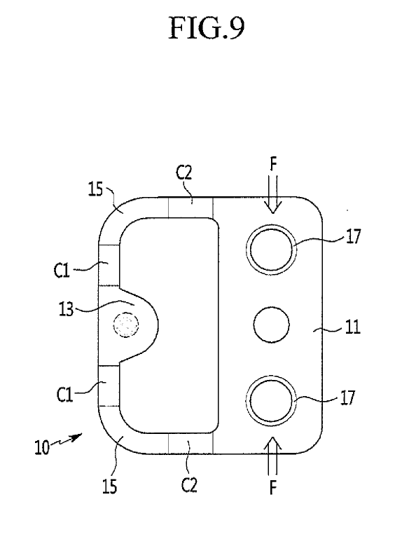

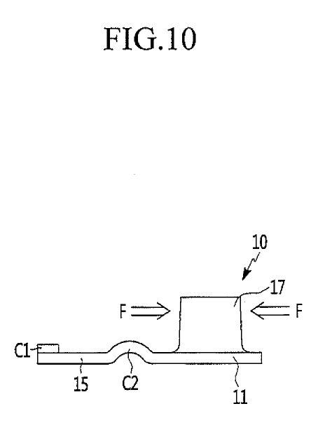

Hereinafter, functions of the curved portions, particularly the vertical curved portion C1 and the horizontal curved portion C2 will be described in connection with FIGS. 8-10. As shown in FIG. 8, the curved portions C may be allowed to be elastically deformed due to their shapes. For example, although welding surfaces of the curved portions C are not flat, but rather are provided with bends, curves and so on, elasticity of the horizontal curved portion C2 may allow the engaging portion 11 to adhere to the rear side of the retainer 20. Further, while the welding surfaces of the curved portions C may not be particularly fit to weld, for example there is angle differences θ between welding surfaces, the engaging portion 11 may be adjusted to adhere to the rear side of the retainer 20 by adjusting (e.g. folding or unfolding) the horizontal curved portion C2 at the angle θ (e.g. with a rubber mallet and the like). As shown in FIG. 9 and FIG. 10, in accordance with striker units of the present invention, after connecting the engaging plate 10 and the striker 30, adjustment of position differences or connecting angle differences between the striker 30 and the door latch may be possible. Further, even if the welding portion 13 is connected to the retainer 20 by welding (W), the position of the engaging portion 11 may be adjusted by deforming the vertical curved portion C1 and/or the horizontal curved portion C2. For example, referring to FIG. 9, when the striker 30 is hit for adjusting the connecting angle differences between the striker 30 and a door latch (e.g. by using a rubber mallet or the like), a force F is transferred to the bolt engaging portion 17 along an arrow direction shown in the drawing, and the vertical curved portion C1 of the connecting portion 15 is deformed so that position of the engaging portion 11 may be adjusted. Further, referring to FIG, 10, when the striker 30 is hit for adjusting clearance between the striker 30 and a door latch (e.g. by using a rubber mallet or the like), a force F is transferred to the bolt engaging portion 17 along an arrow direction shown in the drawing and the horizontal curved portion C2 of the connecting portion 15 is deformed so that position of the engaging portion 11 may be adjusted. Thus, in accordance with the present invention, when an external force F is transferred for adjusting the clearance or connecting angle differences between the striker 30 and a door latch, the vertical curved portion C1 and the horizontal curved portion C2 are allowed to be deformed so as to adjust the position of the engaging portion 11, thereby preventing damage and distortion of the vehicle's side outer panel 3.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A door striker unit for a vehicle, comprising:
a retainer connected to a rear side of a vehicle's side outer panel;
a engaging plate connected to a rear side of the retainer; and
a striker on a front side of the vehicle's side outer panel, the striker connected to the engaging plate;
wherein the engaging plate comprises:
a welding portion welded to the retainer;
an engaging portion having a bolt engaging portion integrally formed therein for connection with the striker; and
a connecting portion integrally connecting the welding portion and the engaging portion, the connecting portion comprising a protruding curved portion.

2. The door striker unit of claim 1, wherein the bolt engaging portion is cylindrically shaped and comprises a thread formed therein.

3. The door striker unit of claim 1, wherein the curved portion comprises:
a vertical curved portion formed proximal to the welding portion; and
a horizontal curved portion formed proximal to the engaging portion.

4. The door striker unit of claim 3, wherein the curved portion is has a semicircular shape.

5. The door striker unit of claim 1, wherein the striker comprises:
a striker plate; and
a striker ring connected to the striker plate.

6. The door striker unit of claim 5, wherein the striker plate further comprises a marking groove formed therein, the marking groove corresponding to a position of a marker formed in the vehicle's side outer panel.
